(19) United States
(12) Patent Application Publication
(10) Pub. No.: US 2006/0023858 A1
(43) Pub. Date: Feb. 2, 2006

(54) Subscriber alterable locator service

(76) Inventors: Susanne M. Crockett, Buffalo Grove, IL (US); Robert B. Lasken, Schaumburg, IL (US)

Correspondence Address: Paul Barenie, Esq., No. 612, 2158 45th Street, Highland, IN, 46322-3742, US

(21) Appl. No.: 10/903,829

(22) Filed: Jul. 30, 2004

(51) Int. Cl. H04M 3/42

(52) U.S. Cl. 379/201.06

(57) ABSTRACT

A method and system are provided for implementing locator service over a telephone network, a subscription for the locator service being alterable by a subscriber of the locator service, including a subscriber graphic user interface (GUI), and a locator service platform in communication with the GUI. The subscriber GUI allows the subscriber to provide locator service information including a company branch telephone number and company branch location. The platform includes a memory device that stores locator service information for use in the implementation of the locator service, and a locator service controller coupled with the memory device. The locator service controller communicates with the subscriber GUI, receives at least the company branch telephone number and company branch location information, and updates the subscriber's location service subscription responsive to information received at the subscriber graphic user interface.

### TECHNICAL FIELD

This invention is directed to a service provided over the telephone network, and more particularly, to a subscriber alterable locator service provided over the telephone network.

### BACKGROUND ART

A Locator Services may be utilized, for example, by a company (i.e., a pizza chain, hotel chain, etc . . . ), in directing telephone calls associated with a companies telephone number, for example, the companies toll-free telephone number. The locator service typically directs incoming telephone calls to the company toll free number, based on the location of the calling party, and of the company branch locations. Specifically, the locator service, upon receiving an incoming call to the company toll free telephone number, determines the location of the calling party, and selects one or more company branch locations responsive to locator service parameters. For example, the locator service may select the closest company branch location to the calling party location, or may select all company branch locations within a particular mile radius of the calling party location.

In order to take advantage of a locator service, a company subscribes to the locator service from the local telephone company, where the locator service is associated with a telephone number for the company. Upon subscribing to the locator service, the company provides the telephone company personnel with a telephone number and addresses of at least some of the company branches. The telephone company personnel then use this information to set up the locator service subscription for the company, by entering at a telephone company personnel computer terminal, typically a Unix terminal, the company branch location telephone number, address, and any other locator service parameters used in selecting a company branch. The telephone company personnel then activate the locator service for the company (subscriber).

After activation, when a telephone call is received at the company toll-free number, the locator service determines the location (latitude, longitude) of the caller. This may be accomplished by using the central office location serving the caller, by prompting the caller to enter a zip code at the DTMF keypad of the telephone, or by cross-referencing the calling party telephone number with an external database to determine the zip code of the calling party, where the zip code of the calling party may be converted to latitude and longitude coordinates. The location of the calling party is then compared with the locations of the company branches. The locator service then selects the company branch from the database that is closest, or within a particular radius of the calling party, accounting for other locator service parameters in making the selection, as discussed below.

When providing information to the telephone company personnel for setting up their locator service, the subscriber may set various parameters used by the locator service when determining how to direct incoming call to the company toll free telephone number. For example, the company may specify that the locator service direct incoming calls to a closest company branch to the calling party. In the alternative, the subscriber may specify that the locator service direct incoming telephone calls to a company branch within a particular x-mile radius of a particular company branch. Where the locator service determines that there are more than one company branch within the x-mile radius of the caller, the locator service may respond to the caller by providing, via voice prompts, the various company locations (i.e. street addresses of the locations) to the customer within the x-mile radius, and allowing the customer to select which company branch the call will be forwarded using the DTMF keypad on the telephone. Further, the subscriber may specify that the locator service direct incoming calls to company branches that are currently open for business, by providing hours and/or days of operation for the particular company branches. In addition, or in the alternative, the subscriber may specify that incoming telephone calls from particular geographic regions are directed only to a subset of company branch locations, where the locator service may select the company branch from the subset based on the calling party proximity to the company branch, and possibly accounting for other locator service parameters.

When the company desires to alter their locator service subscription (i.e. delete or add company locations, change location telephone numbers, address, or other locator service parameters used in determining how to direct an incoming telephone call), they must either call up the telephone company, and make minor modifications via voice prompts, such as alternate termination changes, or they may utilize telephone company personnel to make changes to their locator service subscription via a written change request to the telephone company. The former allows changes to the database without using telephone company personnel, however, the changes that can be made are limited and must be done through a cumbersome voice-prompt structure. The latter requires telephone company personnel, and the change requests are often processed one or more days after they are requested, and accordingly leave the company with inaccurate locator service subscription information until the change request is processed.

This invention is directed to solving one or more of the problems discussed above.

### BRIEF DESCRIPTION OF SEVERAL VIEWS OF THE DRAWINGS

FIG. 1 is a block diagram of a telephone network over which a subscriber alterable locator service may be implemented, in accordance with an embodiment of the invention;

FIG. 2 illustrates an exemplary subscriber graphic user interface through which a locator service subscriber may provide locator service information including a company branch telephone number and company branch location, in accordance with an embodiment of the invention;

FIG. 3 illustrates an exemplary graphic user interface allowing a subscriber to upload a file having locator service information, including at least one company branch telephone number and company branch location information, in accordance with an embodiment of the invention;

FIG. 4 is a flow chart illustrating implementation of a subscriber alterable locator service subscription in accordance with an embodiment of the invention;

FIG. 5 illustrates an exemplary locator service database field format, in accordance with an embodiment of the invention;

FIG. 6 is a flowchart describing operation of the subscriber alterable locator service, in accordance with an embodiment of the invention;

FIG. 7 illustrates a subscriber GUI allowing a subscriber to create a time-dependent routing plan, in accordance with an embodiment of the invention;

FIG. 8 is a subscriber GUI allowing a subscriber to view and select for editing previously created time-dependent routing actions for the time-dependent routing plan, in accordance with an embodiment of the invention;

FIG. 9 illustrates a subscriber GUI for editing a pre-existing time-dependant routing action in accordance with an embodiment of the invention;

FIG. 10 illustrates a subscriber GUI allowing a subscriber to provide time-dependent routing action information, in accordance with an embodiment of the invention;

FIG. 11 is an exemplary database file for storing time-dependent routing information, in accordance with an embodiment of the invention;

FIG. 12 illustrates an exemplary subscriber GUI allowing a subscriber to create a voice prompt, in accordance with an embodiment of the invention;

FIG. 13 illustrates an exemplary subscriber GUI allowing a subscriber to manage previously defined voice prompts, in accordance with an embodiment of the invention; and

FIG. 14 illustrates an exemplary subscriber GUI allowing a subscriber to edit previously defined voice prompts, in accordance with an embodiment of the invention.

### DETAILED DESCRIPTION OF THE PREFERRED EMBODIMENT

A method and system are provided for implementing a locator service over a telephone network, a subscription for the locator service being alterable by a subscriber of the locator service, including a subscriber graphic user interface (GUI), and a locator service platform in communication with the GUI. The subscriber GUI allows the subscriber to provide locator service information including a company branch telephone number and company branch location. The platform includes a memory device that stores locator service information for use in the implementation of the locator service, and a locator service controller coupled with the memory device. The locator service controller communicates with the subscriber GUI, receives at least the company branch telephone number and company branch location information, and updates the subscriber's location service subscription responsive to information received at the subscriber graphic user interface.

Having a subscriber alterable locator service subscription allows a subscriber to create or modify a locator service subscription without the intervention of telephone company personnel. A subscriber may then create or modify the locator service subscription at any time of the day. Further, the locator service subscription may be created or edited in real-time, or near real-time, as it is not necessary to wait for service to be created or modified by the telephone company personnel.

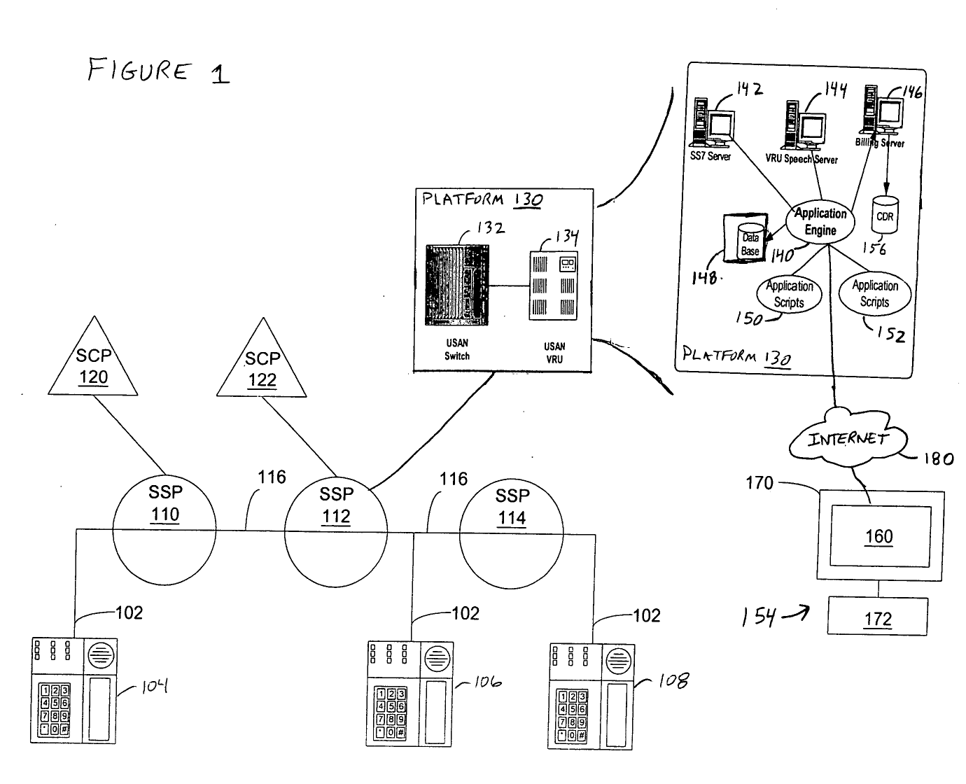

A block diagram of an exemplary telephone network 100 for providing a subscriber alterable locator service subscription is shown in FIG. 1, in accordance with an embodiment of the invention. As shown in FIG. 1, a plurality of telephone lines 102 are shown, connecting a plurality of telephone network locations 104, 106 and 108 via service switching points (SSPS) 110, 112 and 114 respectively. The SSPs 110, 112 and 114 are connected via trunked communications lines 116, which are used to connect and carry communications signals, for example, voice and/or data, between two or more of the telephone network locations 104, 106 and 108.

Service control points (SCPs) 120 and 122 may be coupled with SSPs 110 and 112, respectively, and provide advanced intelligent network (AIN) capabilities to the telephone network, as well as routing information to the SSPs of the telephone network describing how a telephone call from a calling party to a called party is to be routed. A locator service platform 130 is coupled with an SSP, for example, the SSP 112, and provides a subscriber alterable locator service subscription, where a subscriber may provide locator service information including a telephone number and location of a company branch, as will be described further below.

The locator service platform 130 may include switching and interactive voice response unit (VRU) capabilities. For example, the platform may include a platform switch 132 (i.e. a platform SSP), capable of interfacing with an external SSP (i.e., the SSP 112) to receive incoming telephone calls from a calling party to the platform. The switch 132 is coupled with an interactive voice response unit (VRU) 134 that provides voice response capabilities for use in implementing the locator service, for example, for playing pre-recorded messages or performing text-to-speech reading of messages to a calling party, and by receiving responses such as voice response or DTMF tone detection from the calling party.

The switch 132 and VRU 134 may be implemented as shown in the expanded portion of FIG. 1, as an applications engine 140, coupled with SS7, VRU speech and Billing servers 142, 144 and 146, respectively. The application engine 140 may further be coupled with a memory device 148 (i.e., including one or more databases used in implementing the subscriber alterable locator service subscription or other services provided by the platform), and one or more applications scripts 150, 152. The application engine 140 may communicate with a subscriber host 154 to provide a subscriber GUI 160. The subscriber host 154 typically comprises a display 170 and a controller such as a computer 172, capable of displaying the locator service subscriber GUI 160 to the subscriber. The subscriber host 154 may communicate with the application engine 140, for example, via the Internet 180.

The application engine 140 receives at least a company branch telephone number and company branch location information from the subscriber via the subscriber GUI 160, and updates the subscriber's locator service subscription in the memory device 148 responsive to the information received at the subscriber GUI 160. The application engine 140 may then be used to provide the locator service, accounting for the information received from the subscriber GUI 160.

The application engine 140 may comprise, for example, one or more locator service controllers (not shown) operating under one or more application scripts 150, 152, providing programming for controlling operation of the application engine 140 in providing the functionality for implementing a subscriber alterable locator service or other services offered by the platform. The SS7 server 142 has capabilities for parsing received SS7 messages, and for generating SS7 messages, for example, to communicate to the SSP 112 to indicate that a received telephone call from a calling party is to be routed to a company branch selected at the application engine 140. The VRU server 144 has capabilities for providing the VRU functionality discussed herein, such as for providing text-to-speech messages or pre-recorded messages to a calling party, and for receiving responses from the calling party such as DTMF tone detection and/or voice response from a calling party. The billing server 146 handles the determining and storing of billing information for the platform 130, where the billing information may be stored in a memory device 156 such as Compact Disc Recordable device, for storing billing information at the platform 130. Although not shown, additional or alternative servers may be provided, where it is desirable to communicate with an SSP or other telephone network equipment external to the platform, for example, using AIN, Internet or other communication protocols.

As would be appreciated by one skilled in the art, each of the SS7, VRU and Billing servers 142, 144 and 146, respectively, may be implemented using separate controllers operating under separate programming, for example, provided from memory devices present within the respective servers. The servers 142, 144 and 146 are capable of communicating with the applications engine 140 under one or more communications protocols, as would be appreciated by one skilled in the art. In the alternative, the functionality provided by the servers 142, 144 and 146 may be implemented at the applications engine 140, through one or more controllers. Further, the applications engine has capabilities for communicating with the subscriber GUI 160, for example, using PPP, TCP/IP, or other known communication protocols, as would be appreciated by one skilled in the art.

The platform 130 discussed above may be implemented, for example, as a Readi800 topology, created and maintained by United States Advanced Networks. Such a topology may include, for example, a Readi800 Web Server having capabilities for communicating with a subscriber via a subscriber GUI, a Readi800 Application database and Tomcat Server having firewall capabilities to protect the platform 130 and telephone network 100 from unwelcome access and attacks from unauthorized users, Readi800 Call Processing Equipment, and Internet routing capabilities. The components of the platform 130 may be coupled, for example, by Ethernet connections, using Cat 5 cable, or by any other fashion allowing the various components within the platform 130 to communicate with one another.

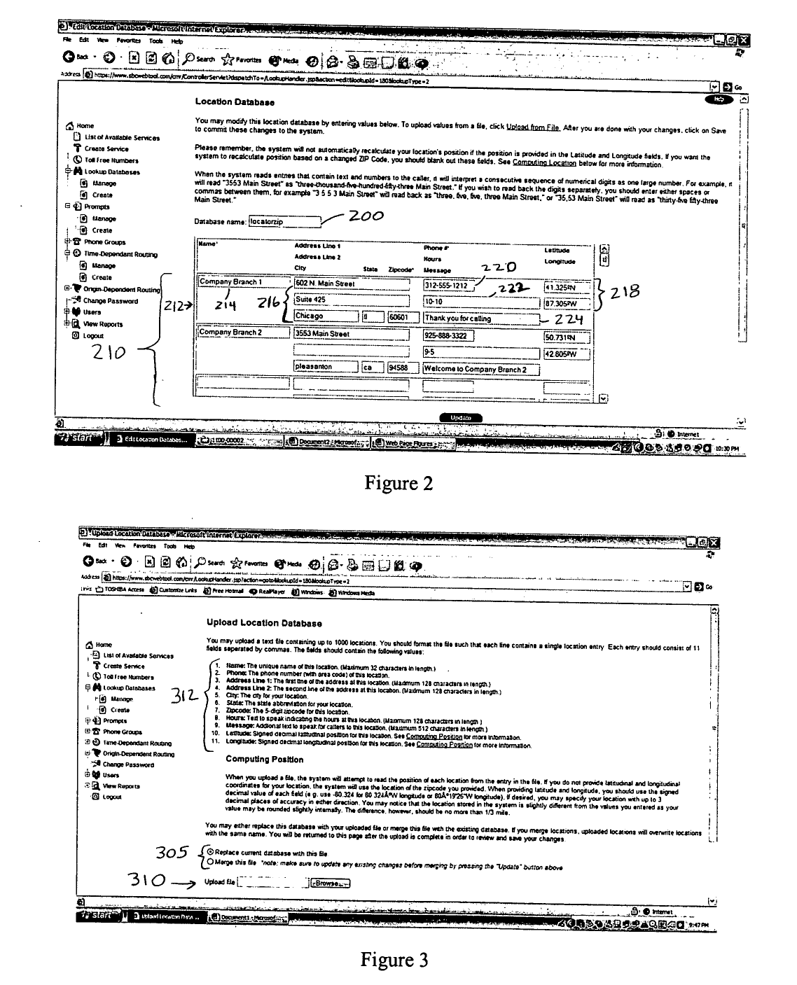

Various exemplary subscriber GUIs 160 are illustrated with respect to FIGS. 2-3, 7-10, and 12-14, in accordance with various embodiments of the invention.

FIG. 2 illustrates an exemplary subscriber GUI through which a locator service subscriber may provide locator service information including a company branch telephone number and company branch location, in accordance with an embodiment of the invention. As shown in FIG. 2, various locator service information fields are provided for a subscriber to enter locator service information. At a name field 200, a subscriber may enter a locator service name that corresponds, for example, to a database file name stored within the memory device 148 of the platform 130. The database file includes locator service information for the subscriber that is used by the application engine 140 in implementing the locator service. The database file name may correspond to an existing database file stored at the memory device 165. In this circumstance, the locator service information from the existing database file is displayed within the fields generally indicated at 210, where a subscriber may edit information within the database file, as well as delete company branch locations, or add additional database entries corresponding to, for example, additional company branch locations. In the alternative, the subscriber may enter a new locator service name in the name field 200, where a user may provide information regarding one or more company branch locations at the GUI fields 210.

More specifically, a subscriber may provide information for a company branch location at 212. Such information may include a company branch name 214, and company branch location information. The company branch location information may include information regarding the street address 216 for the company branch location, and/or the latitude and longitude coordinates 218 for the company branch location. Other locator service information that may be provided by the subscriber for a company branch location may include the telephone number 220 for the company branch, the company branch hours of operation 222, and a message 224 that may be provided before, or during a directing of the call to that company branch location. Similar information may be provided for additional company branch locations. Although only locator service information fields are shown for 2 company branch locations, locator service information fields for any number of company branch locations may be provided to the subscriber for entering locator service information. Latitude and/or longitude coordinates corresponding to zip code of the street address field 216 provided by the subscriber may be used where latitude and/or longitude information 218 is not provided by the subscriber.

FIG. 3 illustrates an exemplary graphic user interface allowing a subscriber to upload a file having locator service information, including at least one company branch telephone number and company branch location, in accordance with an embodiment of the invention. As shown in FIG. 3, a subscriber is provided an option 305 to replace a current data base file with the uploaded file, or to merge a current data base file with the uploaded file. A subscriber may then select 310 the particular file including the locator service information to be uploaded for their locator service subscription. Further shown in FIG. 3 is locator service information 312 that may be provided in the file to be uploaded. For example, locator service information that may be provided for a particular company branch location may include a branch location name, phone number, address line 1, address line 2, city, state, zip code, hours of operation, message information, and latitude and longitude information. Latitude and/or longitude coordinates corresponding to the zip code of the street address may be used where latitude and/or longitude information is not provided.

The file to be uploaded by the subscriber via the subscriber GUI may be generated using a text editor, and saved in ASCII format, where each line of the text file represents a different company branch location. Each line of the text file may include the locator service information 312, where each piece of information of the information 312 (i.e., name, phone, address line 1, etc . . . ) is separated by a deliminator, such as a comma. Where latitude and/or longitude information is not provided for a particular company branch location, the latitude and/or longitude information corresponding to the zip code for the company branch may be used to derive the latitude and/or longitude information. The text file may include a maximum number of company branch location entries if desired, for example, 1000 location entries, or in the alternative, may provide any number of location information entries.

The subscriber provided locator service information capable of being provided via the graphic user interfaces of FIG. 2 and/or FIG. 3 may then be utilized by the application engine 140 of the platform 130 in providing the locator services discussed further below. For example, when a calling party dials a company's telephone number that subscribes to the locator service, and the call is routed to the platform 130. The application engine 140 has capabilities for determining the calling party location, and comparing the calling party location to the company branch location information provided by a subscriber via the exemplary GUIs of FIGS. 2 and 3. The application engine 140 may then select one or more company branch locations from the company branch data base using the location information for the particular company branch. The application engine 140 may then direct the calling party telephone call to the telephone number of the selected company branch location(s), as will be discussed further below.

The hours of operation 224 may be used by the application engine 140 in determining whether to route a calling party to a particular company branch location. In one circumstance, for example, where a particular company branch is selected to be connected with the calling party, the hours of operation may be provided to the calling party by a text-to-speech option where locator service controller has capabilities for converting text entered in the hours of operation field 224 to speech that is read to the calling party. The message field 226 may provide a message that is read, using text-to-speech capabilities, to a calling party. The message may be read before directing the calling party to the selected company branch location, or, in the alternative, instead of directing the calling party telephone call to a selected company branch location, as will be discussed further below.

Providing a subscriber graphic user interface through which company branch location information including telephone number and location information may be provided, allows subscribers to create or modify a locator service subscription without the intervention of telephone company personnel. A subscriber may then create or modify the locator service subscription at any time of the day. Further, the locator service subscription may be created or edited in real-time, or nearly real-time, as it is not necessary to wait for service to be created or modified by the telephone company personnel.

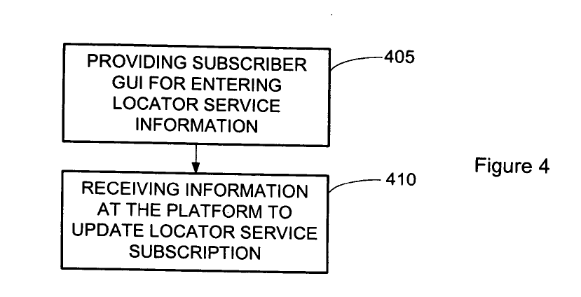

FIG. 4 is a flow chart illustrating implementation of a subscriber alterable locator service subscription in accordance with an embodiment of the invention. The flowchart of FIG. 4 will be discussed with respect to the block diagram of FIG. 1. As shown at box 405, a subscriber GUI 160 is provided for entering locator service information including, for example, a telephone number and location of a company branch. The subscriber GUI 160 may be provided using the application engine 140, the memory device 148, the internet 180, and a display 170 of the subscriber PC 172. Specifically, the application engine 140 may receive a request from a subscriber of the locator service to access a subscriber GUI 160. The application engine 140 may request from the subscriber authentication information, such as a user name and password, to ensure the subscriber has access privileges to alter a locator service subscription. Upon receiving authentication information, the application engine 140 may access the memory device 148 for information regarding the subscriber's locator service subscription. Such information may include information regarding various company branch locations, as well as user selectable parameters allowing the subscriber to control how the application engine 140 selects a company branch location to which a calling party is connected. The application engine 140 then provides the retrieved information from the memory device 148 through the internet 180 as a subscriber GUI 160 at the display 170 of the subscriber PC 172. Such a subscriber GUI 160 is provided, for example, as an internet web page, such as is shown in FIGS. 2 and FIG. 3, or as discussed below.

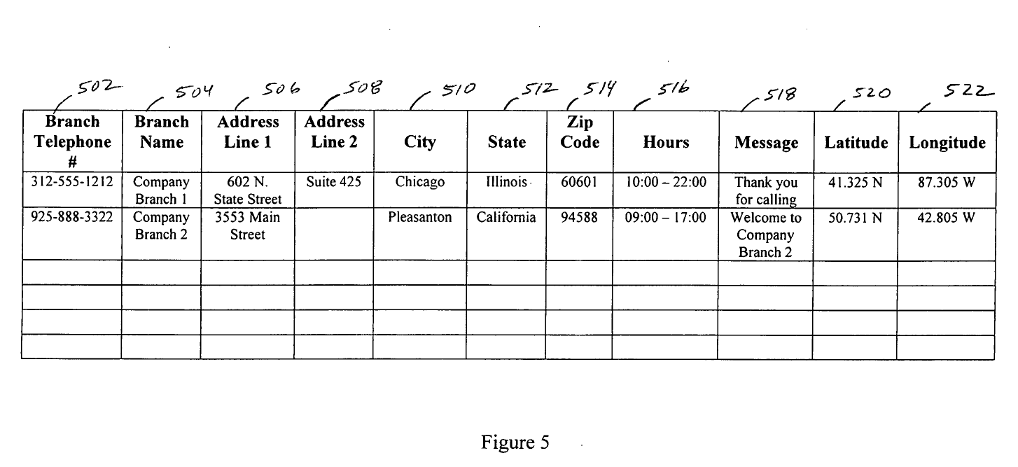

As shown at box 410, information is received at the platform 130 from the subscriber GUI 160, and is used to update a subscriber's locator service subscription. This may be accomplished, where the application engine 140 determines information entered at various fields of the subscriber GUI 160, for example, information fields shown in FIG. 2, or as received via an uploaded file as discussed with respect to FIG. 3, and stores the information regarding the subscriber's locator service subscription at the memory device 148. An exemplary locator service database field format is illustrated in FIG. 5, in accordance with an embodiment of the invention.

As shown in FIG. 5, database fields of a database file stored at the memory device 148 may include fields including branch telephone number 502, company branch name 504, address Ln. 1 506, address Ln. 2 508, city 510, state 512, zip code 514, hours 516, message 518, latitude 520 and longitude 522 fields. More or less database fields may be provided.

The application engine 140 is programmed to provide locator service information to and receive information from the subscriber GUI 160, including locator service information including a telephone number and company branch location information, and to store the information in the appropriate field of the database file. For example, the information entered at the subscriber GUI 160 for company branch name 214 (FIG. 2) may be stored at the Name field 504, wherein the information provided at the street address field 216 is stored by the application engine 140 in the Address Ln. #1 506, Address Ln. #2 508, City 510, State 512 and Zip Code 514 fields of the database file. Information entered at the telephone field 220 of the subscriber GUI 160 is stored at the Telephone Number 502 field, information in the hours field 222 is stored at the Hours field 516 of the database, and the information entered at the message field 224 is stored at the Message field 518 of the database file. Latitude and Longitude information 218 provided by the subscriber at the subscriber GUI 160 is stored by the application engine 140 at the latitude and longitude fields 520 and 522, respectfully, of the memory device 148. The order of the database fields shown in FIG. 5 is not important, and other database field ordering may be used.

In a similar fashion, the application engine 140 is capable of extracting any of the locator service information 312 provided as a file uploaded via the subscriber GUI 160 shown in FIG. 3.

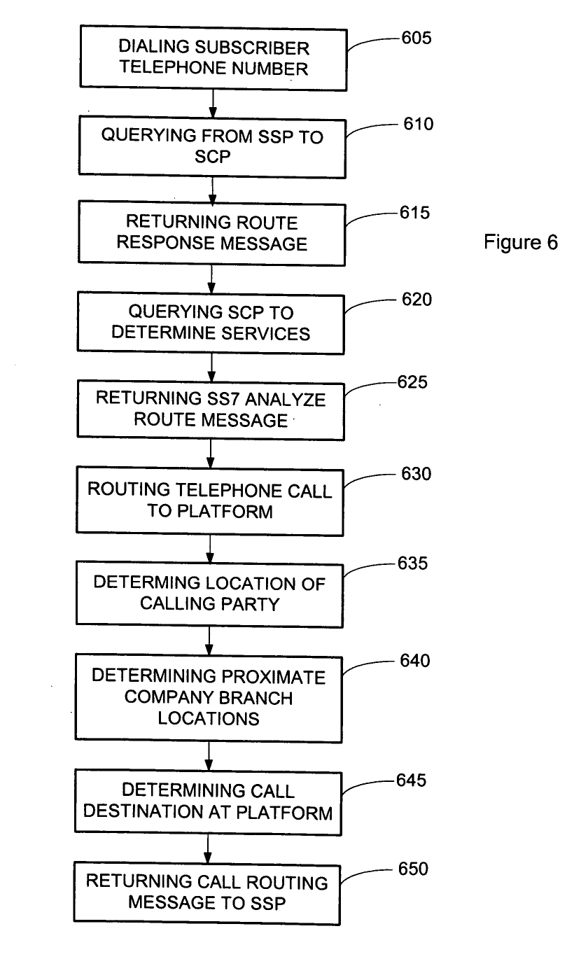

A flowchart describing operation of the subscriber alterable locator service allowing a subscriber to provide locator service information to the platform is shown in FIG. 6, in accordance with an embodiment of the invention. The flowchart of FIG. 6 will be discussed with respect to the system block diagram of FIG. 1, the subscriber GUI 160 shown in FIG. 2, and the exemplary database file shown in FIG. 5.

As shown in FIG. 6, a calling party dials a telephone number of a company, at box 605. The calling party may be, for example, the network location 104 shown in FIG. 1. The company telephone number may be, for example, a toll-free telephone number for the company. Further, the company is a subscriber of the locator service, where the company has capabilities for altering their locator service subscription using a subscriber GUI, as discussed above. The locator service has capabilities for directing the calling party telephone call to a company branch location, for example, the network locations 106 and 108, corresponding to a company branch location #1 and a company branch location #2, respectively.

Upon receiving a calling party telephone call to the company toll-free telephone number, the SSP 110 serving the calling party performs an 800 query to a local service control point (SCP) 120 at box 610, for routing instructions, for example, utilizing the SS7 communications protocol. The SS7 communication protocol is well-known, and is discussed in greater detail in U.S. Pat. No. 6,097,802 to Fleischer, III et al., assigned to SBC Technology Resource Group, Inc., and hereby incorporated by reference herein. The SCP 120 returns a route response message to the SSP 110 at box 615, using the SS7 communications protocol. The route response message indicates to the SSP 110 that the telephone call is to be routed to a portion of the telephone network servicing the toll-free telephone number, for example, the SSP 112. The routing message may include a carrier identifier, as is appreciated by one skilled in the art. The SSP 112 receives the telephone call from the calling party, and is capable of determining an appropriate SCP, here the SCP 122, for determining services (i.e. the locator service) to which the company toll-free number is linked. The SSP 112 queries the SCP 122 for services linked to the company telephone number at box 620. The SCP 122 determines that the company toll-free telephone number is a subscriber of the locator service, and at box 625, returns an SS7 Analyze Route Message to route the telephone call to the switch and trunk group serving the platform 130.

As shown at box 630, the calling party telephone call is routed to the platform 130. The application engine 140 determines the location of the calling party at box 635. This may be accomplished, for example, by the application engine 140 querying the memory device 148, or some external database, for the location of the calling party 104. Such a determination is discussed in detail in U.S. Pat. No. 6,097,802, mentioned above, and may be accomplished by determining a zip code for the calling party, and cross-referencing the calling party zip code to external databases for determining latitude and longitude coordinates for the calling party. In the alternative, it would be apparent that the locator service may query the calling party for their zip code, or use a zip code of the SSP serving the calling party.

The application engine 140 then determines a company branch location(s) proximate to the calling party at box 640. This may be accomplished, for example, by the application engine 140 accessing the memory device 148 for locator service information for the company, including the location information for the company branches, and determining company branch location(s) proximate by distance to the calling party location 110, depending on parameters set by the company (subscriber). For example, the application engine 140 accesses the memory device 148 for a file associated with the company locator service subscription. The application engine 140 retrieves the location information, including company branch telephone number and company branch location information that may have been provided by the subscriber via the subscriber GUI 160, for example, the latitude and longitude coordinates fields 520 and 522, or the zip code field 514. Where the application engine 140 utilizes zip code information, the application engine has capabilities for utilizing other internal or external databases to determine company branch location using the zip codes, as would be appreciated by one skilled in the art, for example, as described in U.S. Pat. No. 6,097,802 to Fleischer III et al. Upon retrieving the location information from the memory device 148 for company branch locations, the application engine 140 determines distances between the calling party and the company branch locations. For example, the distance determination may be made by determining a distance between the latitude and longitude coordinates for the calling party and the latitude and longitude coordinates for a company branch.

The application engine 140 then determines a call destination at box 645, which is the company branch location(s) that meet the locator service parameters provided by the subscriber, for example, via the subscriber GUI 160. For example, the subscriber may specify that the call destination be the closest company branch to the calling party. Alternatively, the subscriber may specify that company branch locations within a specified mile radius of the calling party be presented to the calling party (i.e. via the VRU capabilities of the platform 130), and the subscriber selects the company branch to which his call is directed. The application engine 140 then retrieves the telephone number corresponding to the determined company branch.

The application engine 140 then returns an SS7 call routing message to the SSP 112 at box 650, indicating that the incoming call is to be routed to the appropriate company branch location. Such a message may be generated by SS7 server functionality present within the application engine 140.

It will be appreciated, that the locator service may be configured in a way to provide a voice message such as “I am sorry, there are currently no company branch locations close to your location” where the platform 130 determines that there are no company branch locations within a predetermined number of miles of the calling party. Such a message may be provided, for example, using text-to-speech VRU server 144 capabilities of the platform 130. Further, before the platform 130 sends the call routing message at 650, the platform may provide a voice message to the caller. The voice message may be a text-to-speech message specific to the determined company branch telephone number. For example, the application engine 140 may retrieve the message from the subscriber database file stored at the memory device 148, and specifically the message field 518 corresponding to the determined company branch location.

In addition, the platform 130 may account for information provided in the Hours field 516 of the subscriber database file, that provides hours of operation for a company branch location. For example, when determining the company branch location closest to the calling party, the application engine 140 may exclude company branch locations that are not open for business at the time the calling party calls the company toll-free number. In the alternative, the application engine 140 may not exclude company branch locations that are not open for business, but rather, if it is determined that a company branch is the closest to the calling party but not open for business, a voice message may be provided to the calling party indicating the hours of operation of the company branch, and requesting the calling party to call back during business hours.

In this way, a subscriber alterable locator service subscription is provided, allowing a subscriber capabilities for creating or updating its locator service subscription via a subscriber GUI 160. The locator service then operates in accordance with the locator service information received via the subscriber GUI 160, including company branch telephone number and company branch location information.

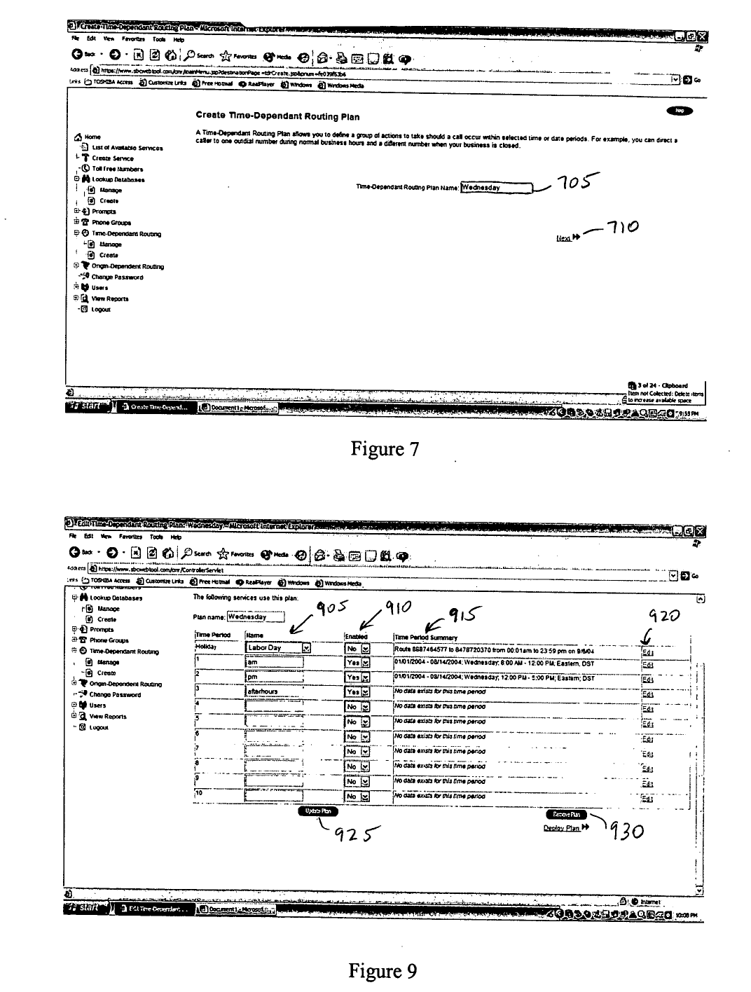

In accordance with another embodiment of the invention, a subscriber GUI 160 is provided allowing a subscriber to provide time-dependent routing information that may be used in conjunction with a locator service subscription. The time-dependent locator service routing may be used to specify when one or more of the company branch locations are available, or unavailable, to receive an incoming telephone call from a calling party. FIGS. 7-10 illustrate subscriber GUIs allowing a subscriber to create, or to select a previously created time-dependant routing plan of a locator service, in accordance with another embodiment of the invention.

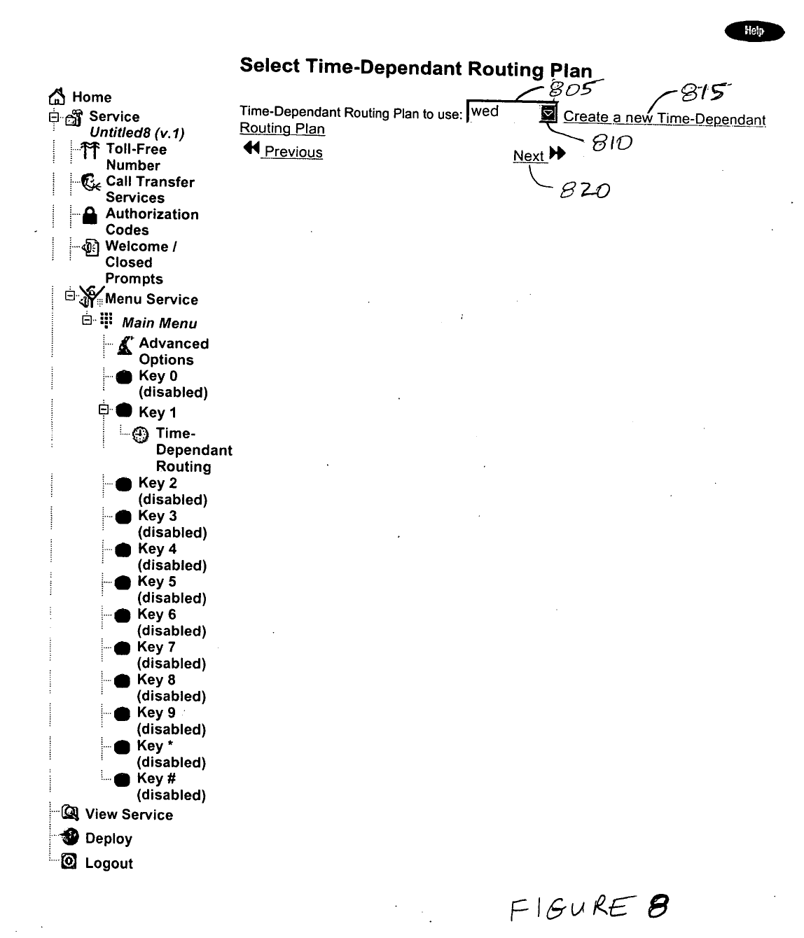

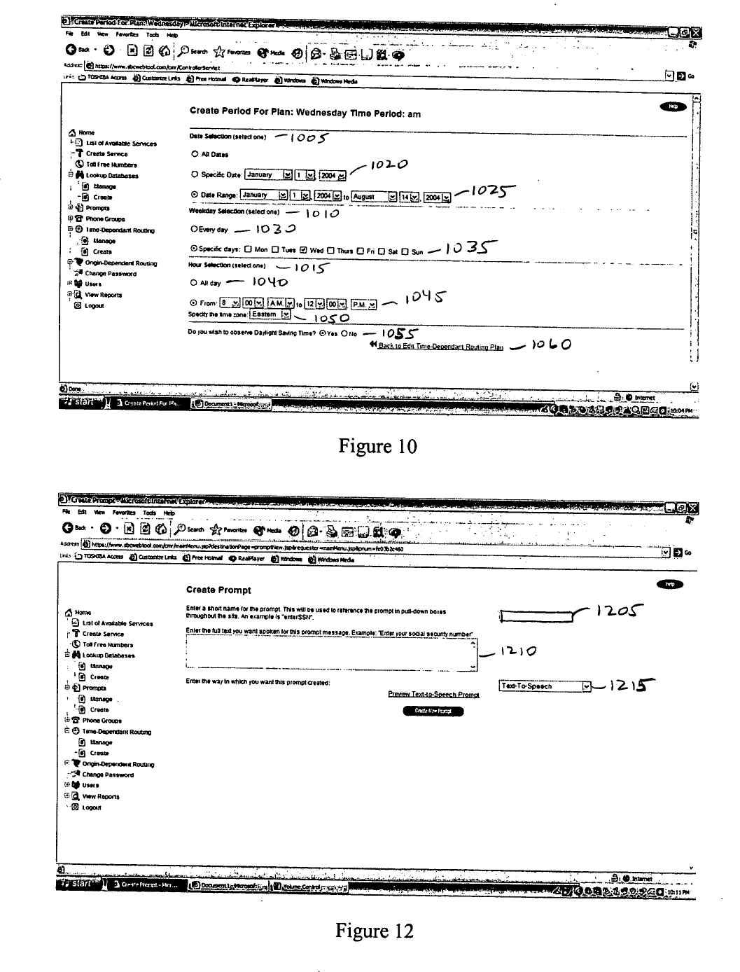

FIG. 7 illustrates a subscriber GUI allowing a subscriber to create a time-dependent routing plan, in accordance with an embodiment of the invention. As shown in FIG. 7, a subscriber may provide a name for a time-dependent routing plan at a time dependent routing plan name field 705. Upon entering the name, the subscriber may select a “next” link 710 to define the time-dependent routing plan, as discussed with respect to FIGS. 9 and 10. Where the subscriber is editing a previously defined time-dependent routing plan, the subscriber may be provided a time-dependent routing selection GUI as shown in FIG. 8.

As shown in FIG. 8, the subscriber may be provided with a time-dependent routing selection field 805, for selecting a time-dependent routing plan that has been previously defined. The subscriber may select the routing plan via a drop-down menu displayed using the drop-down arrow 810. A create new plan link 815 may be provided, for example, to provide the subscriber an option to create a new time-dependent routing plan, by providing the subscriber GUI shown in FIG. 7. Upon selecting a previously defined time-dependent plan 810, the subscriber may select a ‘next’ link 820 to access an edit time-dependent routing plan screen, for example, also as shown in FIGS. 9 and 10. The subscriber GUIs to edit the time-dependent plan in the case of a previously created plan, or to create the time-dependent plan, may be the same, except for the information that populates the fields of the subscriber GUI. For example, when the subscriber selects to edit a previously created time-dependent routing PATENT plan, information regarding the previously defined plan is presented in the editing subscriber GUI. In contrast, where the subscriber is creating a new time-dependent plan, the subscriber enters the information regarding the plan, as discussed below.

FIG. 9 illustrates a subscriber GUI for altering a pre-existing time-dependant routing plan or creating a new routing plan, in accordance with an embodiment of the invention. As shown in FIG. 9, a subscriber is presented information at 905 regarding routing action names for the routing plan, where a routing action describes a particular action that may be defined within the time-dependent routing plan. The subscriber is further presented with an indication as to whether the listed routing actions are enabled or not at 910. The subscriber is also presented with summary information for defined actions at 915, and an option to edit a particular routing action at 920. Once all routing actions are created or edited for the routing plan, the subscriber may select to update their routing plan at 925, or remove the plan at 930.

To create a routing action for the routing plan, the subscriber enters a name for the action in one of the action name fields 905, and selects the corresponding edit link 920. Where there are previously defined routing actions for the routing plan, the subscriber may select the edit link 920 corresponding to the routing action the subscriber desires to edit. Upon selecting an edit link 920, the subscriber is provided with the subscriber GUI shown in FIG. 10.

FIG. 10 illustrates a subscriber GUI allowing a subscriber to provide time-dependent routing action information in accordance with an embodiment of the invention. As shown in FIG. 10, a user is provided capabilities for providing information for a time dependent routing action, such as date selection 1005, weekday selection 1010, and hour selection 1015. Date selection 1005 allows a subscriber to provide information regarding the specific calendar date 1020, or date range 1025, that an action will occur. The weekday selection 1010 allows the subscriber to provide the days of the week that the action is to occur, for example, within the selected date range 1025. For example, the subscriber can indicate that the action is to occur on every weekday at 1030, or at selected week days 1035.

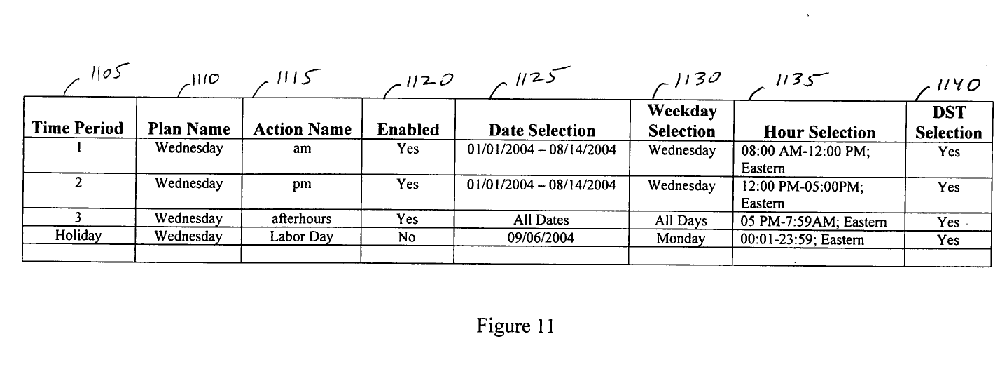

The hour selection 1015 allows the subscriber to provide information regarding whether the action will occur at all hours of the day at 1040 for the selected date 1005 and/or weekdays 1010, or during a particular range of hours 1045 provided by the subscriber. The subscriber may additionally specify the time zone at 1050, that is used when determining whether the action will be carried out. The subscriber is given an additional option whether to observe daylight savings time at 1055. Where a subscriber is editing a previously defined action for a time-dependent routing plan, the existing action information is retrieved from a database and presented to the subscriber for editing. When the subscriber has completed providing action information, he may return to the subscriber GUI of FIG. 9 using the return link at 1060, and create or edit other time-dependent routing actions. An exemplary database file for storing time-dependent routing information is shown in FIG. 11, in accordance with an embodiment of the invention.

As shown in FIG. 11, an exemplary database file for storing time-dependent routing information may include fields of information including time period 1105, plan name 1110, action name 1115, enabled information 1120, date selection information 1125, weekday selection 1130, hour selection 1135, and daylight savings time selection 1140. When presented with the subscriber GUIs of FIGS. 7-10, for entering time-dependent routing information, the application engine 140 (FIG. 1) is able to access the time-dependent routing information file for the subscriber, and provide the information from one or more of the database fields of FIG. 11 in the appropriate fields of the subscriber GUIs of FIGS. 7-10. For example, the information from the plan name field 1110 may be provided in the drop-down menu when the subscriber is selecting a plan name at plan name field 805, and any action name fields 905 may be populated with information retrieved from the action name fields 1115 of the database file. The enabled/disabled field 910 of the subscriber GUI may be populated using the enabled database field 1120 information, and information regarding date selection 1005, weekday selection 1010 and hour selection 1015 fields may be populated using information from the respective date, weekday and hour selection database fields 1125, 1130 and 1135. Information for whether daylight savings time is observed may be retrieved from the DST selection field 1140 of the database.

In a similar fashion, any time-dependent routing information provided by a subscriber at the various information fields of the subscriber GUIs of FIGS. 7-10, may be stored by the application engine 140 in corresponding fields of the database file shown in FIG. 11.

The time-dependent routing information shown, for example, in FIGS. 7-10, may be entered for each company branch location, and used by the platform when providing the locator service. The actions may represent time periods during which telephone calls are not to be routed to a particular company branch location. In this circumstance, the company branch may be considered as not available by the platform 130, and not considered in the determination as to a closest company branch location to the calling party. Such a determination of availability using time-dependent routing information may be made, for example, by the application engine 140, before the determination of the closest company branch, in which case, the company branch location is not considered in the location determination. However, the determination of availability may be made after a closest company branch location determination, wherein if the company branch is determined unavailable because of time-dependent routing information, the application engine 140 may simply select the next closest company branch location to the calling party.

In the alternative, the routing actions 905 may represent time periods during which incoming telephone calls to the company toll-free telephone number may be routed to the respective company branch location. In a further alternative, the actions may represent time periods during which incoming telephone calls to the company toll-free telephone number are to be routed to a default telephone number, or time periods during which a calling party is presented with a voice message explaining that the company branch location is currently unavailable for business. It will be appreciated by one skilled in the art, that time-dependent routing information may be provided in addition, or in the alternative, for the company toll-free number, in a similar fashion as discussed above.

In accordance with another embodiment of the invention, a subscriber may provide voice prompts to be presented to a calling party, at various points during the call routing by the locator service. For example, the voice prompts may be provided upon the determination of the closest company branch location, thanking the calling party for his call, and describing the selected company branch before routing the call. The description may be a text-to-speech providing of name and/or address information for the company branch, hours of operation, or a message, for example, reading the company branch information from any of the database fields described above with respect to FIG. 5. Alternate voice prompts may be created by a subscriber, as described with respect to FIG. 12-14. FIGS. 12-14 illustrate exemplary subscriber GUIs allowing a subscriber to create a voice prompt in accordance with an embodiment of the invention.

FIG. 12 illustrates an exemplary subscriber GUI allowing a subscriber to create a voice prompt, in accordance with an embodiment of the invention. As shown in FIG. 12, a prompt name 1205 may be provided by the subscriber. The subscriber may then enter the prompt text 1210, and indicate how the prompt is to be presented at 1215. Alternatively, a subscriber may create a .WAV file on their PC, and upload the .WAV file to the platform. In this circumstance, the subscriber may indicate the uploaded .WAV file name at the prompt name 1205, indicating that the .WAV file is to be used for the voice prompt.

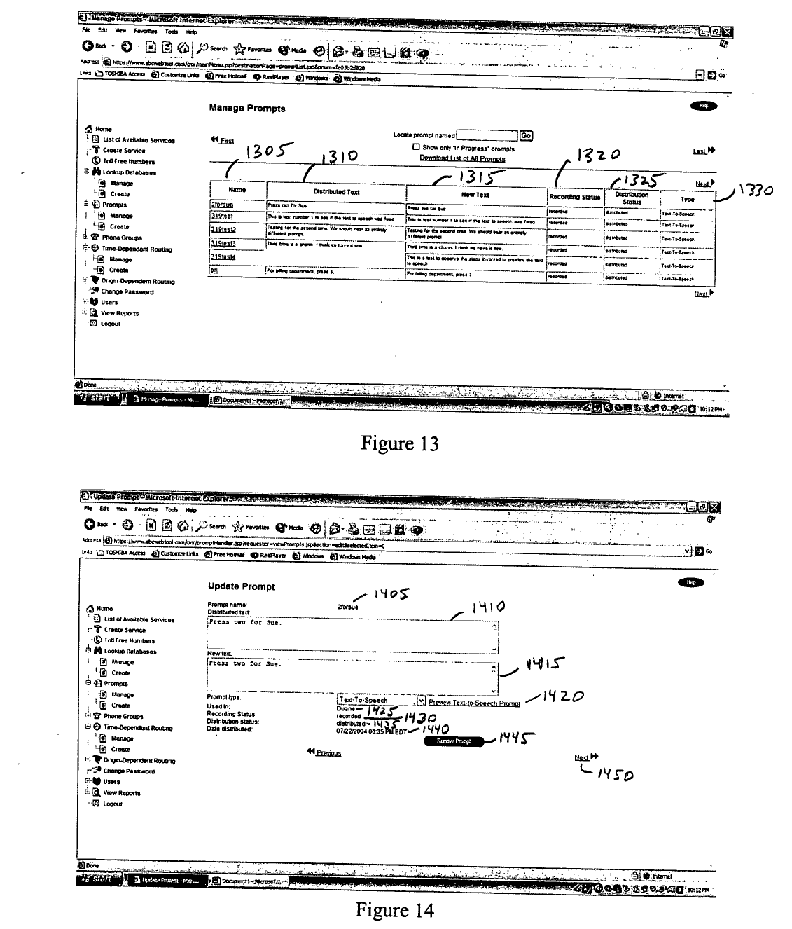

FIG. 13 illustrates an exemplary subscriber GUI allowing a subscriber to manage previously defined voice prompts, in accordance with an embodiment of the invention. As shown in FIG. 13, the subscriber is provided with voice prompt names 1305 for previously created voice prompts. Information regarding distributed text for each voice prompt is provided at 1310, where distributed text is text-to-speech information that has been downloaded to the text-to-speech server. The subscriber is further provided with information regarding new text for a prompt at 1315, for example, where the subscriber wishes to change their prompt, and a recording status for the particular voice prompts at 1320. In addition, a distribution status for the voice prompts is provided at 1325, for example, indicating that a prompt has been distributed to the VRU for use, as well as a type of voice prompt indication at 1330, indicating, for example, whether the voice prompt is a text-to-speech prompt, or an uploaded .WAV file. A subscriber may further edit a particular voice prompt, for example, by selecting the voice prompt name 1305 for the particular prompt to be edited. FIG. 14 illustrates an exemplary subscriber GUI allowing a subscriber to edit previously defined voice prompts, in accordance with an embodiment of the invention.

As shown in FIG. 14, the subscriber is provided in formation regarding the voice prompt name 1405 selected for editing, the distributed voice prompt text 1410 for the prompt, and capabilities for changing the text associated with the voice prompt at 1415. Further, the subscriber may alter the voice prompt type at 1420, and is further provided with information regarding the particular subscriber services (i.e. locator service) with which the prompt is used at 1425, as well as information regarding the recording status, distribution status and date of distribution of the prompt at 1430, 1435 and 1440, respectively. A subscriber may in addition, select to remove the prompt altogether at 1445. Upon selecting the ‘next’ link 1450, the subscriber may be provided, for example, with general information regarding the updated prompt (not shown).

The information received regarding the voice prompts via the subscriber GUIs of FIGS. 12-14 may be stored by the application engine 140 in a database file for the voice prompts, for example, using database fields corresponding to the information fields of the subscriber GUIs of FIGS. 12-14, in a similar fashion as described above. Similarly, information may be retrieved from the database file to populate the various voice prompt information fields discussed with respect to FIGS. 12-14, where the application engine 140 accesses the database file for the respective voice prompt information, in a similar fashion as discussed above.

Although the various databases discussed above each show a specific number of database entries, such database file representations are merely exemplary, and one skilled in the art would realize that any number of database entries may be provided for each of the respective database files. Further, although multiple exemplary database files are described, one skilled will appreciate that the information stored in the various databases may be maintained in a single database file, or any other number of database files, so long as the application engine 140 is programmed with information regarding from which database(s) to retrieve the various information stored. Further, although the information is described as being stored in the form of one or more database files at the memory device 148, one skilled will realize that the information may be stored in other formats, so long as the application engine 140 is sufficiently programmed for retrieving the data.

Although the system diagram of FIG. 1 describes the connection between the subscriber GUI 160 and the platform 130 as an Internet connection, one skilled will appreciate that other connection schemes are possible. For example, the subscriber GUI may be provided via a peer to peer connection between the subscriber PC 172 and the platform 130, for example, via a dedicated dial-up telephone number. Such a telephone number may support any communications format capable of allowing the platform to receive information from, and provide information to, the scriber GUI 160. Such communication between the subscriber PC 172 and the platform 130 may be made using broadband communication capabilities over the phone line, for example, any xDSL service such as ADSL, VDSL, and HDSL. The broadband service may include any other type of broadband service that may operate using any frequency band over the telephone subscriber twisted wire pair.

The subscriber GUIs 160 discussed herein may be completely provided to the subscriber by the platform 130 via the communication channel between the subscriber and the platform. In the alternative, the subscriber may be provided with subscriber GUI software defining multiple subscriber GUIs, such that the platform need only send the information to populate the various information fields to provide locator service specific information to the subscriber, and retrieve the information entered into the various information fields by the subscriber. Any combination of the former may be implemented.

The platform 130 has been discussed as being implemented in a telephone network having AIN capabilities. One skilled in the art will realize that the telephone network need not have AIN capabilities for the platform to function, so long as any of the SSPs within the telephone network are capable of routing a telephone call from the calling party to a locator service subscriber to a platform capable of providing the locator service. Further, it will be apparent, that although the platform has been described as being a separate network entity, the functionality described with respect to the platform may be incorporated in other telephone network components, for example, an SCP, or SSP, of the telephone network, while achieving the advantages discussed herein.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for implementing a locator service provided over a telephone network, a subscription for the locator service being alterable by a locator service subscriber, comprising:
providing a subscriber graphic user interface through which the subscriber may provide locator service information including a company branch telephone number and company branch location; and
receiving information from the subscriber graphic user interface at a platform used in the providing of the locator service, the platform capable of updating the subscriber's locator service subscription responsive to the received information.

2. The method of claim 1, wherein the providing a subscriber graphic user interface includes providing a subscriber graphic user interface including a plurality of information fields for entering information including the company branch telephone number and company branch location.

3. The method of claim 2, wherein the information regarding the company branch location includes a zip code for the company branch.

4. (canceled)

5. The method of claim 1, wherein the providing a subscriber graphic user interface includes prompting a subscriber for a computer file, the computer file including information regarding at least one company branch and company branch telephone number.

6. The method of claim 5, wherein the information regarding the company branch location includes a zip code for the company branch.

7. (canceled)

8. (canceled)

9. The method of claim 1, wherein the information regarding the company branch location includes a zip code for the company branch.

10. (canceled)

11. (canceled)

12. The method of claim 1, wherein the providing a subscriber graphic user interface includes providing a subscriber graphical user interface via the Internet.

13. The method of claim 1, wherein the providing the subscriber graphic user interface further comprises providing the subscriber graphic user interface through which the subscriber may provide availability information regarding the availability of a company branch location for receiving telephone calls, and the receiving information includes updating the subscriber's locator service subscription responsive to the received availability information.

14. The method of claim 13, wherein the availability information includes hours of operation for the company branch.

15. The method of claim 1, wherein the subscriber has defined at least one speed dial code corresponding to a company branch location, and the providing information including a company branch telephone number includes a speed dial code.

16. A system for providing a locator service subscription implemented over a telephone network, a subscription for the locator service being alterable be a locator service subscriber, comprising:
a subscriber graphic user interface through which the subscriber may provide locator service information including a company branch information including a company branch telephone number and company branch location;
a platform, in communication with the subscriber graphic user interface, including
a memory device that stores locator service information for use in implementing the locator service, and
a locator service controller coupled with the memory device, that communicates with the subscriber graphic user interface, and that receives at least the company branch telephone number and company branch location information, and updates the subscriber's locator service subscription responsive to information received at the graphic user interface.

17. The system of claim 16, wherein the subscriber graphic user interface includes a plurality of information fields for entering information including the company branch telephone number and company branch location.

18. The system of claim 17, wherein the information regarding the company branch location includes a zip code for the company branch.

19. (canceled)

20. The system of claim 16, wherein the subscriber graphic user interface includes a company branch information computer file, the company branch computer file including information regarding at least one company branch and company branch telephone number.

21. The system of claim 20, wherein the information regarding the company branch location includes a zip code for the company branch.

22. (canceled)

23. The system of claim 16, wherein the subscriber graphic user interface is provided using the locator service controller, a display, and a subscriber interface, where:
the locator service controller is adapted for running a software program to interface with a subscriber by providing and receiving information regarding the locator service;
the display is capable of presenting the locator service information to the subscriber; and
the subscriber interface is capable of communicating with the platform to receive and provide information regarding the locator service to the subscriber.

24. A telephone network for providing a subscriber alterable locator service, comprising:
a service switching point for receiving a telephone call from a calling party to a company telephone number, and routing the telephone call to a platform used in implementing the locator service, and
the platform, in communication with the service switching point, and including
a memory device that is capable of storing locator service information for use in implementing the locator service, and
a locator service controller coupled with the memory device, that is capable of communicating with the subscriber graphic user interface to receive locator service information including a telephone number and location for a company branch, storing the received information in the memory device, determining a calling party location, determining a company branch location responsive to the calling party location and accounting for the received information from the subscriber graphic user interface, and providing a company branch telephone number for the company branch location to the service switching point,
wherein the service switching point routes the telephone call from the calling party to the provided company branch telephone number.

25. A method of implementing a subscriber alterable locator service over a telephone network, comprising:
receiving at a service switching point a telephone call from a calling party to a company telephone number;
routing the telephone call to a platform used in implementing the locator service, the platform including a memory device that is capable of storing locator service information for use in implementing the locator service, and a locator service controller coupled with the memory device, that is capable of communicating with the subscriber graphic user interface to receive locator service information including a telephone number and location for a company branch, storing the received information in the memory device;
determining at the platform a company branch location responsive to the calling party location and accounting for the received information from the subscriber graphic user interface; and
providing from the platform a company branch telephone number for the company branch location to the service switching point;
wherein the service switching point routes the telephone call from the calling party to the provided company branch telephone number.
